(19) United States
(12) Patent Application Publication
(10) Pub. No.: US 2006/0117021 A1
(43) Pub. Date: Jun. 1, 2006

(54) Shared account information method and apparatus

(75) Inventors: Matthew Sidney, Fitchburg, WI (US); Christine M. Benson, Madison, WI (US); Sashidhar Bellam, Madison, WI (US); Davin Sannes, Mount Horeb, WI (US); Daniel J. Donoghue, Oregon, WI (US)

Correspondence Address: QUARLES & BRADY LLP, 411 E. WISCONSIN AVENUE, SUITE 2040, MILWAUKEE, WI, 53202-4497, US

(73) Assignee: Epic Systems Corporation

(21) Appl. No.: 11/132,876

(22) Filed: May 19, 2005

Related U.S. Application Data
(60) Provisional application No. 60/631,308, filed on Nov. 29, 2004.

(51) Int. Cl. G06F 17/30

(52) U.S. Cl. 707/10

(57) ABSTRACT

A method and apparatus for use with a computer network system including a server, a database and a plurality of interfaces wherein client medical information is stored in separate client accounts for each of a plurality of clients including at least a first client, the interface for accessing client account information, the method for authorizing a second client to access at least a portion of the first client's account information via one of the interfaces, the method comprising the steps of, via one of the interfaces, accessing the first client's account and authorizing the second client to obtain at least a specific subset of the first client's account information and storing an indication in the database indicating that the second client is authorized to access the specific subset of the first client's account information.

### CROSS-REFERENCE TO RELATED APPLICATIONS

This patent is related to provisional patent application No. 60/631,308 that is titled “Shared Account Information Method and Apparatus” and that was filed on Nov. 29, 2004.

### BACKGROUND OF THE INVENTION

The present invention relates to electronic medical records/information access and more specifically to a system wherein access of medical records/information associated with a first person can be obtained by a second person or may be granted to the second person in a streamlined fashion.

Recently systems have been developed that provide electronically networked personal medical information portals or accounts for clients (i.e. patients) of medical facilities (e.g., clinic, hospital, etc.). For instance, by accessing a personal medical account, a client can access personal medical information; obtain information regarding healthy lifestyles; receive communications from physicians regarding recent examinations or test results; provide information to physicians regarding ailments and other medical conditions and access schedules for physicians and the like at medical facilities for the purpose of scheduling appointments.

One concern when providing medical information via electronic networks has been maintaining the confidentiality of sensitive client information. To facilitate confidentiality, facilities that support systems of the above type typically adopt strict rules regarding creation of personal medical accounts and access to personal medical accounts. With respect to creating a personal medical account, some facilities create personal medical accounts for all clients as an added service. Thus, when a client has a first appointment with a physician at a medical facility and client specific information is initially gathered, the client's account is automatically set up and is essentially immediately useable by the client.

In other cases clients are required to apply for an account and, in this regard, to provide client specific information. For instance, application information may include the client's social security number, mother's maiden name, address information, phone number, date of birth, etc. To provide the application information, a client may be required to manually fill out a paper request form and submit the form to the facility that supports the account system. In the alternative, some systems include on-line web (e.g., internet) based systems where clients provide information required to set up their personal medical information accounts.

After a client applies for a medical information account, an account may be immediately created automatically if sufficient identifying information has been provided. K alternatively, the request information may be sent to a system administrator who sets up a new account for the requesting client. In some cases, where the client has either failed to provide all of the required information or has provided incorrect information, the client may need to be contacted to obtain the additional required information. As part of the setup process, each client is provided with a personal user name and password.

To access a personal medical account, a client accesses a log on page that provides log on instructions as well as fields for entering the client's user name and password. When a recognized user name and password combination are entered by a client, in at least some cases, information is provided in an intuitive browser format with hyperlinks between browser pages and different information types. For instance, one hyperlink may be to historical patient medical records while another may be to recent test results or a specific type of test result. As another instance, other hyperlinks may be to a scheduling program for a particular physician or medical facility, to notices from physicians regarding test results or analysis of other personal information or to pages including preventive health information.

Thus, by enforcing specific account creation rules and requiring user name and password entry to access accounts, sensitive information is maintained confidential.

In at least some cases, specific clients for which accounts are provided may either not be in a position to use the account information themselves or may want another client to have access to at least some of their account information for consultation or other purposes. For instance, a two year old child cannot use a typical personal computer and therefore, while an account may be assigned to a two year old child, the account will go unused by that child. As another instance, a fifteen year old child that is dealing with cancer may want a parent to have access to the child's account so that the parent can track progress in fighting the disease, to communicate with attending physicians, to schedule appointments for the child, etc. In yet another instance, care givers of elderly patients who are very ill or are incapacitated may wish to gain access to the patient's account to aid the patient in providing care or tracking medical treatment of the patient.

Similarly, there may be instances where someone other than a client associated with an account may want access to at least some account information. For instance, where a parent is the guarantor of payment for medical services, a parent may want and have authority to obtain medical services cost information for a fifteen year old child. Similarly, a parent of a fifteen year old child may want to obtain access to the child's account for reviewing the child's medical information as well as for scheduling medical service appointments. In some cases, due to legal and private medical information concerns, the access given to a parent may be need to be limited to only a subset of medical information.

Currently, for a person other than the client associated with an account (i.e., the account owner) to gain access to the account, the client either has to provide the client's user name and password to the person that wants access or a formal request for access has to be submitted to the facility supporting the account system. Usually, clients are discouraged from providing their user names and passwords to other people as such unfettered access makes it impossible to track when the other person accesses account information and which information is accessed. Where a person requests access to a different client's account, the request is typically reviewed by a system administrator that may or may not authorize access depending on the relationship between the client and the requesting person. For instance, where the requesting person is a parent of a two year old child that “owns” an account, the request may be granted. However, where the requesting person is unrelated to the client associated with an account the request would typically be denied. Where a client requests that another person should have access to the client's account the request is typically granted.

Where a request by a second person or client to access a first client's account is granted, if the second client does not have her own medical information account or has no relationship with the entity that provides accounts, an account is provided and the second client is provided an access code for accessing the first client's account via the second client's account. Here, when the second client accesses the second client's account, an option is provided to access the first client's account information via entry of the assigned access code. Hereinafter, access by one client into another client's account will be referred to as “proxy access” unless indicated otherwise.

While medical information account systems of the above kind have proven to be valued by clients and supporting facilities alike, such account systems have several shortcomings. First, the process required to facilitate proxy access is particularly burdensome on both access requesters and facility staff charged with regulating access. To create the accounts, significant administrative overhead is placed on the organization providing the accounts to manage and create the accounts. Also, in many families there is one person that generally manages family business including scheduling medical service appointments for all family members. For instance, in many families one parent is primarily responsible for taking children to medical services appointments and therefore those appointments have to fit into the parent's schedule. Here, the parent usually makes medical services appointments for children and, in many cases, for another parent or other family members (e.g., a live in grandmother or grandfather, etc.). The parent may also be responsible for reviewing lab results for children, managing medical records and managing other aspects of care for family members. Hereinafter, a person that manages appointments and medical information generally for a family will be referred to as a “family manager” or “manager”.

Because most families have one family manager, in most cases, where personal medical accounts are employed, the manager requests access to accounts associated with all family members. The requirement to request access to all family member accounts one at a time is tedious and time consuming. In many cases the burden of requesting access to all family member accounts is too great and family managers simply forego the option instead relying on more traditional ways of scheduling appointments and receiving test results such as using the telephone, hard copy reports, etc., which defeats the purpose of the account system as a whole.

Moreover, where a family manager takes the time required to request access to all family member accounts, each request has to be analyzed by a facility administrator to ensure that the manager has proper authority to access and then the administrator has to take steps to facilitate access and assign an access code for each of the managed accounts. These administrative tasks are tedious and time consuming.

Second, where access to multiple accounts is granted to a manager, the manager has to keep track of multiple access codes. For instance, where a wife manages for her husband as well as five children and the wife's mother, the wife has to keep track of seven different access codes in addition to her own user name and password. Tracking codes is burdensome. In an attempt to address this problem, some systems have been developed that allows a client with proxy access to switch between accounts once logged in without entering another user's name, password or access code. However, this solution to the problem still only allows the client to access one account at a time.

Third, where a manager manages appointments for multiple other people, it is difficult to get a complete picture of all the schedules and requirements for all of the other people that the manager manages for. For instance, where a wife manages accounts for herself, her husband, mother and five kids, the wife is required to access eight different accounts (including the wife's portal) to get a full glimpse of all the schedules and related information for the people for whom she manages. Similarly, to schedule appointments for a sub-set of the people for whom she manages, the manager has to access the account for each person for which an appointment is to be scheduled.

Here, one goal when scheduling multiple appointments may be to schedule appointments temporally proximate for multiple persons thereby minimizing the number of trips to medical facilities. Where a manager has to flip among accounts to identify suitable appointment times for multiple persons, the manager may be confused and make unintended appointments or appointments that are not optimally timed relative to each other. At the very least flipping among accounts to schedule appointments is tedious.

Fourth, in at least some cases, while a client may want another person to be able to access certain information on the client's personal medical account, the client may want at least a sub-set of account information to remain completely confidential. For instance, while a child may be comfortable with a parent accessing most account information, the child may not want her parents to be able to access the results of certain tests (e.g., AIDS, sexually transmitted diseases, etc.) or even the fact that certain test types have been performed or other portions of the child's medical records. Known systems do not provide easy ways for account users to mark specific information as completely confidential or require some type of administrative intervention to accomplish such special treatment of information.

Fifth, currently there is no known way for the client to automatically restrict the duration of proxy access once granted. For instance, in at least some cases a teenager associated with an account may want to grant access to a parent for a period of two months and thereafter may want to restrict access for various reasons.

Sixth, when a proxy accesses another person's account, it would be advantageous if the client associated with the account and/or the entity providing the account could track when access occurred, the information accessed by the proxy, and any actions taken or activity performed by the proxy, etc.

Thus, it would be advantageous to have a system wherein a client could speedily and simply grant proxy access to another person generally, to only a subset of account information and/or over a period of specified duration. In addition, it would be advantageous if persons that are associated with client's in special ways (e.g., managers of families, etc.) could either automatically be granted access to client account information or could obtain access to the accounts in a simplified and speedy fashion. Further, it would be advantageous if a person accessing multiple accounts could be provided with a unified, simultaneous view of those accounts.

### BRIEF SUMMARY OF THE INVENTION

It has been recognized that where client medical information is stored electronically and is accessible remotely via an electronic interface (e.g., a computer) via user names and passwords, it is advantageous to have a system wherein a first client associated with a first account can grant access to a second person so that the second person can also access the information without requiring an administrative intermediary. Similarly, it has been recognized that it is advantageous in at least some cases if a person can request access to a client's information and can be granted access automatically if certain criteria are met such as, for instance, a parent-child relationship, a spousal relationship, etc.

Based on the above realizations, the present invention has been designed to enable client account access and authorization to access in an automated fashion that maintains client information confidentiality while still allowing information sharing. To this end, an exemplary embodiment of the invention includes a method for use with a computer network system including a server, a database and a plurality of interfaces wherein client medical information is stored in separate client accounts for each of a plurality of clients including at least a first client, the interface for accessing client account information, the method for authorizing a second client to access at least a portion of the first client's account information via one of the interfaces, the method comprising the steps of, via one of the interfaces, accessing the first client's account and via the first client's account, authorizing the second client to obtain at least a specific subset of the first client's account information and storing an indication in the database indicating that the second client is authorized to access the specific subset of the first client's account information. Thus, a first client can give authorization to a second client to access the first client's account without requiring action by a system administrator.

In at least some cases the method further includes the step of, after storing and when the second client accesses the second client's account, allowing the second client to access the specific subset of the first client's account information via one of the interfaces. In some cases the step of allowing the second client to access the specific subset includes providing an indication to the second client via the second client's account that the second client can access at least a portion of the first client's account information. In some cases the indication to the second client includes a hyperlink to the specific subset.

In some embodiments a unique access code is associated with each of the client accounts and the step of authorizing the second client to access the specific subset of the first client's account information includes providing an access code associated with the second client's account via the first client's account. Here, the step of accessing the first client's account may include providing the first client's account access code. Here, the method may further include the step of, after storing, accessing the second client's account via one of the interfaces. In some cases the step of accessing the second client's account includes providing the second client's account access code.

In some cases the step of allowing the second client to access the specific subset includes providing tools via one of the interfaces that allow other than the first client to request access to at least a subset of the first client's account information. Here, the step of allowing the second client to access the specific subset of the first client's account information via one of the interfaces may include receiving a request via one of the interfaces from a requesting client other than the first client for the specific subset including information useable to identify the requesting client, determining if the requesting client is authorized to obtain the specific subset and, if the authorizing client is authorized to obtain the specific subset, providing the subset.

In some embodiments the method further includes the steps of, after allowing access to the second client, monitoring the second client's access to the specific subset and, when the second client accesses the specific subset, storing information associated with the access. Here, the step of storing information associated with the access may include storing the time of access and an indication of the information accessed. The method may further include the steps of, after allowing access to the second client, monitoring the second client's access to the specific subset and, when the second client accesses the specific subset, providing a notice to the first client via the first client's account that the subset of information has been accessed. Here, the notice may identify the second client.

The step of allowing the second client to access the specific subset may include providing a notice to the second client that the second client may access at least a portion of the first client's account information via one of the interfaces. The step of providing a notice may include one of transmitting an e-mail, providing a voice mail and transmitting a page.

In at least some embodiments the specific subset is a first subset and wherein the step of authorizing the second client to obtain at least the specific subset of the first client's account information includes identifying at least a second subset of the client's account information that is different than the first subset wherein the second client is unable to access the second subset.

In some embodiments the step of authorizing the second client to obtain at least a specific subset of the first client's account information includes specifying a period during which the second client is to be able to access the specific subset and the step of storing including storing the specified period. Here, the method may further include the step of allowing the second client to access the specific subset during the specified period via one of the interfaces.

The step of allowing access may include allowing access to scheduling tools that allow the first client to schedule appointments for the second client.

In some cases the method further includes the step of storing at least one rule useable to identify at least one first relationship between clients, the step of authorizing the second client to obtain at least a specific subset of the first client's account information including receiving an authorization indication, applying the at least one rule to determine if the at least a first relationship exists between the first and second clients, where the first relationship exists between the first and second clients, allowing access to the specific subset via one of the interfaces and, where the first and second client relationship is different than the first relationship, prohibiting access to the specific subset to the second client.

Some embodiments of the invention also include a method for use with a computer network system including a server, a database and a plurality of interfaces wherein client medical information is stored in separate client accounts for each of a plurality of clients, the interfaces for accessing client account information, the method for facilitating client access to other client information, the method comprising the steps of storing at least one rule useable to identify at least a first relationship between clients, accessing a first client's account via one of the interfaces, via the first client's account, indicating a desire to access at least a specific subset of a second client's account information, applying the at least one rule to determine if the at least a first relationship exists between the first and second clients and, where the first relationship exists between the first and second clients, allowing access to the specific subset of the second client's account information via the first interface. Thus, in at least some cases, a first client can request access to a second client's account information and may be granted access if a specific relationship pre-exists.

In some cases the at least one rule that is stored specifies at least one of a parental relationship, a guardian relationship, a guarantor relationship and a common address for the first and second clients. In some cases the method further includes the step of, after the first client's account is accessed, providing an interface tool for identifying the second client. In some cases the method further includes storing client information associated with each client that has a client account and wherein the step of applying the at least one rule includes accessing the client information for at least one of the first and second clients and analyzing the information to determine if the at least a first relationship exists between the first and second clients. In some cases the method further includes the steps of, after allowing access to the first client, monitoring the first client's access to the specific subset and, when the first client accesses the specific subset, storing information associated with the access. Here, the step of storing information associated with the access may include storing the time of access and an indication of the information accessed.

In some embodiments the method further includes the steps of, after allowing access to the first client, monitoring the first client's access to the specific subset and, when the first client accesses the specific subset, providing a notice to the second client via the second client's account that the subset of information has been accessed. Here, the notice may identify the first client.

In some embodiments, when other than the first relationship exists between the first and second clients, the method further includes the step of providing a notice to the second client that another client attempted to access at least a subset of the second client's account information. Here, the method may further include the step of, when the notice is provided to the second client, allowing the second client to authorize the access sought by the first client.

In some embodiments, when other than the first relationship exists between the first and second clients, the method further includes the step of providing a notice to a system administrator indicating that an unauthorized attempted access occurred.

In some embodiments the method further includes the steps of storing at least a second rule useable to identify at least a second relationship between clients, after the step of indicating a desire to access at least a specific subset of a second client's account information, applying the at least a second rule to determine if the at least a second relationship exists between the first and second clients and, where the second relationship exists between the first and second clients, performing a secondary function. Here, the secondary function may include providing a notice to a system administrator that access to the subset of the second client's account information has been requested.

The invention also, in some cases, include a method for use with a computer network system including a server, a database and a plurality of interfaces wherein client medical information is stored in separate client accounts for each of a plurality of clients, the interfaces for accessing client account information, the method for facilitating client access to other client information, the method comprising the steps of storing at least one rule useable to identify at least a first relationship between clients, applying the at least one rule to at least a subset of the client information to identify if at least first and second clients have the at least a first relationship and where the first relationship exists between the first and second clients, allowing the first client to access at least a first subset of the second client's account information. Thus, where specific relationships exist between clients, in at least some cases, the invention contemplates allowing the related clients to gain access to each others information. In some cases the access may be two way while in other cases the access may be only one way (e.g., a parent may be able to access a child's medical records but the child may not be able to access the parents records).

Here, the step of allowing access may include providing information via the first interface indicating authority to access the first client's account information. Here, the step of providing information indicating authority may include providing hyperlink text that is selectable via the interface to access the first subset.

In some cases the method further includes the steps of performing an access obtaining process to grant the first client access to at least a second subset of the second client's account information and, when the first client accesses information corresponding to the second client, simultaneously presenting the first and second subsets of information in an additive fashion. Here, the access obtaining process may include one of the second client granting the first client authority to access the second subset and the first client requesting authority to access the second subset.

Some embodiments include a method for use with a computer network system including a server, a database and a plurality of interfaces wherein client medical information is stored in separate client accounts for each of a plurality of clients, the interfaces for accessing client account information, the method for facilitating client access to other client information, the method comprising the steps of accessing a first client's account via one of the interfaces, via the first client's account, indicating a desire to access at least a specific subset of a second client's account information and providing a notice to the second client that another client has attempted to access at least a subset of the second client's account information. Thus, where one client attempts to access another clients information, in at least some cases a notice is sent to the other client indicating that access was attempted.

In some cases the method further includes the step of, when the notice is provided to the second client, allowing the second client to authorize the access sought by the first client.

Some embodiments include a method for use with a computer network system including a server, a database and a plurality of interfaces wherein client medical information is stored in separate client accounts for each of a plurality of clients including at least a first client, the interface for accessing client account information, the method for authorizing at least another client to access at least a portion of the first client's account information via the interface, the method comprising the steps of via one of the interfaces, accessing the first client's account and, via the first client's account, identifying at least a first subset of the first client's account information that may be accessed by at least a second client.

In some cases the step of identifying includes identifying at least a second subset of the first client's account information that the at least a second client may not access. In some cases the first client's account information includes at least two subsets of information and wherein the step of identifying at least a first subset includes presenting the at least two subsets for selection and receiving a selection of at least one of the presented subsets. In some cases the method further includes the step of, after identifying, allowing the at least a second client to access the first subset of information via one of the interfaces. In some cases the method further includes the step of specifying a time period during which the first subset of information can be accessed.

In some embodiments the invention includes a method for use with a computer network system including a server, a database and at least one interface wherein client medical information is stored in separate client accounts for each of a plurality of clients including at least a first client, the interface for accessing client account information, the method for presenting client account information for multiple clients in an organized fashion, the method comprising the steps of via one of the interfaces, accessing a first client's account and presenting information from a plurality of client accounts via the first client's account.

In some cases the client account information includes appointment schedules for at least a subset of the clients associated with the plurality of clients, the step of presenting including providing a schedule that includes appointments for at least two clients. In some cases the step of providing a schedule includes providing a calendar that indicates appointments for at least two clients.

In some cases the step of presenting includes providing an interface input that allows the first client to switch between information associated with each of the plurality of client accounts. In some cases interface input includes a window including a separately selectable hyperlink element for each of the plurality of client accounts wherein, when one of the hyperlink elements is selected, the method includes presenting information related to the client associated with the selected element. In some cases the method further includes the step of providing a scheduling input via the first client's account that allows the first client to attempt to schedule appointments for each of at least first and second clients at the same time.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a schematic diagram illustrating a system for managing proxy access according to at least some aspects of the present invention;

FIG. 2 is an exemplary access database that may be used with the system of FIG. 1;

FIG. 3 is a flow chart illustrating one method according to at least some aspects of the present invention;

FIG. 4 is a schematic of a window for granting proxy access that may be provided via the display of FIG. 1;

FIG. 5 is a schematic of a window providing notice that proxy access has been granted;

FIG. 6 is a schematic of a window for facilitating proxy access;

FIG. 7 is a flow chart illustrating a subprocess that may be substituted for a portion of the process illustrated in FIG. 3;

FIG. 8 is a schematic of a window illustrating tools usable to indicate that at least some information should be maintained confidential when proxy access is obtained;

FIG. 9 is a flow chart illustrating another method according to at least some aspects of the present invention;

FIG. 10 is a schematic of a window including tools for seeking proxy access;

FIG. 11 is a schematic of a window providing notice that proxy access has been obtained;

FIG. 12 is a flow chart illustrating a subprocess that may be substituted for a portion of the process illustrated in FIG. 9;

FIG. 13 is a schematic of a window illustrating a list of clients managed by a manager;

FIG. 14 is a flow chart illustrating another method according to at least some aspects of the present invention wherein the sever of FIG. 1 automatically provides proxy access to group managers;

FIG. 15 is a schematic of a window for scheduling multiple appointments at the same time;

FIG. 16 is a schematic of a window providing notice of proxy activity to a facility client;

FIG. 17 is a schematic of an exemplary proxy access tracking database that may be employed by the system of FIG. 1;

FIG. 18 is a schematic of a window showing current proxy access restrictions for a particular accounting;

FIG. 19 is a schematic of a window for setting a time restriction for proxy access; and

FIG. 20 is a schematic of a medical account home page window providing various options including several proxy management options.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

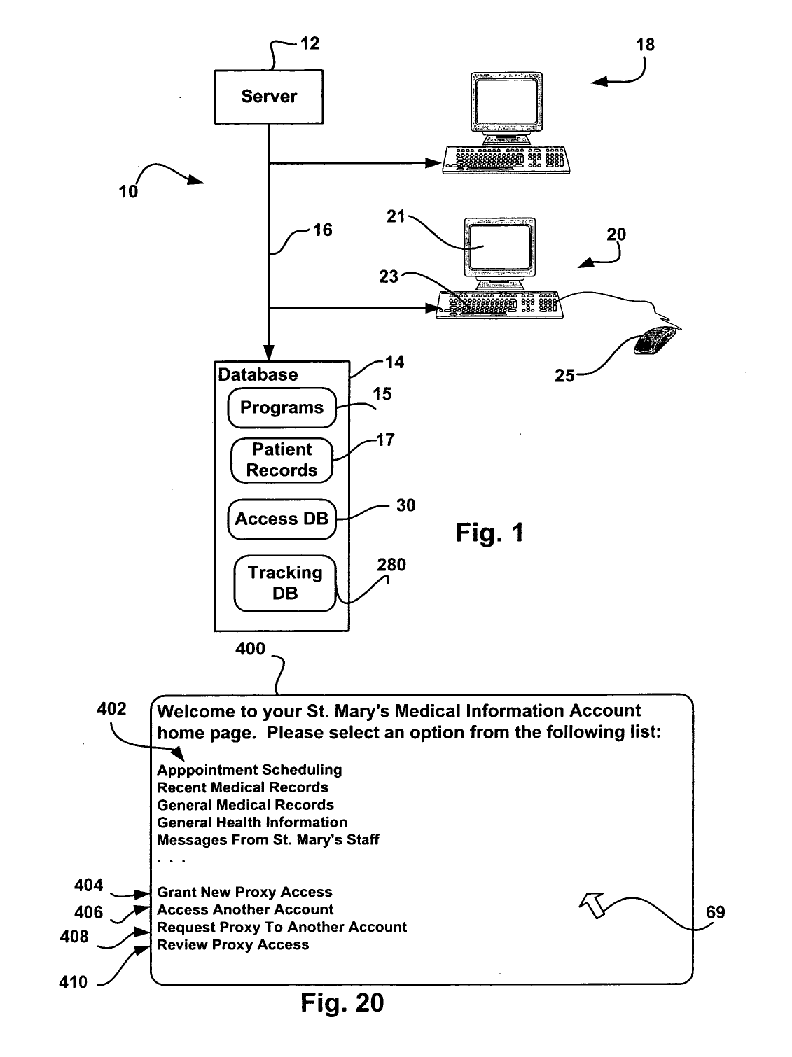

Referring now to the drawings wherein like reference numerals correspond to similar elements throughout the several views and, more specifically, referring to FIG. 1, the present invention will be described in the context of an exemplary system 10 including a server 12, a database 14, a plurality of personal computers or workstations, two of which are identified by numerals 18 and 20 and a network such as, for instance, the internet, a local area network, a wide area network, etc., that links server 12 to database 14 and to each of computers 18, 20, etc. Hereinafter, while system 10 may be used in many different industries and may be associated with many different facilities or groups of facilities for controlling access to information and controlling schedules of various types of resources, unless indicated otherwise, system 10 will be described in the context of an exemplary medical facility, St. Mary's Hospital, that provides medical services to clients or patients. In addition, unless indicated otherwise, system 10 will be described in the context of an exemplary family served by the employees of St. Mary's Hospital including physicians, nurses, etc., where the family includes a mother and father, Mary Jenkins and Pete Jenkins, respectively, and their three children, Suzie Jenkins, Tom Jenkins and Sarah Jenkins.

Referring still to FIG. 1, server 12 runs programs to perform various methods and processes that are consistent with at least some aspects of the present invention. To this end, in general, server 12 stores patient records and facilitates access to those patient records by patients associated therewith, facility personnel at St. Mary's Hospital and, in at least some cases, by third parties (e.g., relatives, personal representatives, etc.).

To facilitate access to medical information/schedules, as indicated above, each of computers 18 and 20 is linked to server 12 via network 16. While each of computers 18 and 20 may have a different hardware configuration, each facilitates similar functions and, therefore, in the interest of simplifying this explanation, only computer 20 will be described in any detail here. Computer 20 includes an input device 23, 25, etc. that enables a system user to provide information to and to interact with, the programs run by server 12. In addition, computer 20 includes an output device 21 for receiving information from server 12. In the context of the exemplary computer 20 illustrated, the input devices include a keyboard 23 and a mouse 25 and the output device is a display screen 21. Nevertheless, it should be appreciated that the input and output devices illustrated are only exemplary and other input and output devices are contemplated such as, for instance, a track ball type input device, voice recognition software and hardware, a touch sensitive display screen for providing input, an audible output device, etc.

Referring still to FIG. 1, as indicated above, server 12 is linked via network 16 to database 14 for accessing information therein and for storing and updating information therein. Database 14 includes a plurality of sub-databases including, in at least some embodiments, a programs database 15, a patient records database 17, an access database 30 and a tracking database 280. As suggested by the label, programs database 15 includes the programs performed by server 12 to manage patient records, facilitate access to patient records, manage facility resource schedules and facilitate access to those schedules. Patient records database 17 stores patient records for access by system users via computers 18, 20.

While various patient record formats are contemplated, in at least some cases it is contemplated that the patient records may actually be stored as small record sections or subfiles that, when a record is to be presented to a system user, are cobbled together to form the record type to be accessed. For example, where two medical tests have been performed for Mary Jenkins, the test information may be stored as four separate records including first and second records indicating the fact that the tests occurred, the dates and times of the tests as well as the physician's that performed the tests and third and fourth records indicating the results of the first and second test, respectively. In this case, server 12 may be programmed to cobble together the four subfiles in any combination or to format the four subfiles in various ways. For instance, the first subfile indicating that the first test was performed may be formatted as a record along with other information identifying Mary Jenkins without the results of the first test or any information regarding the second test. As another instance, information indicating that the second test occurred and that the results of the second test may be cobbled together as a record without any information regarding the first test. As still one other instance, information indicating that each of the first and second tests occurred and the results of those tests may be cobbled together as a record for presentation to a system user. Records may be stored in other ways as one skilled in the industry will appreciate and indeed the inventive concepts herein will be advantageous when used with many different types/formats or records.

Hereinafter, unless indicated otherwise, it will be assumed that St. Mary's Hospital has the capacity to provide a unique client medical information account for each patient that receives medical services at the hospital. Here, the accounts are supported by server 12 running software stored in programs database 15 where the software provides browser type pages to clients that access accounts. In at lease some cases the browser pages provide a full pallet of medical information options tailored for specific clients including access to medical literature, access to facility resources (e.g., physician, labs, equipment, etc.) schedules and appointment scheduling tools, to personal medical history information, to tools for entering personal medical information for clinician review and tools for entering confidential medical information for personal tracking purposes, to test results, to electronic messaging resources to send and receive messages to and from hospital employees, to send data from personal test equipment, to enter various symptoms, etc.

Referring yet again to FIG. 1, when a facility patient wants to review medical information associated with that particular patient, the patient may use one of computers 18 or 20 to access the patient's medical information account. To this end, the patient may access a browser page provided by server 12 for logging onto the facility network via computer 20. The log-on page will typically include some type of security access system wherein, for instance, the system user will have to enter a user name and password. After the user name and password have been entered, server 12 verifies the user name and password and then facilitates access to the patient's account.

In addition to allowing a specific patient to access the patient's account, in at least some cases it is contemplated that a patient may want to grant a third person (e.g., someone other than the patient or an employee of St. Mary's Hospital in the present example) access the patient's account. For example, in the context of the exemplary family described above, Pete Jenkins may want his wife Mary to be able to schedule appointments for him for routine yearly physicals or other medical procedures. Similarly, each of Mary and Pete's kids, Suzie, Tom and Sarah may also want their mother, Mary, to have the ability to schedule appointments. As another instance, an elderly parent may want his or her children to be able to access the parents' account to examine the results of test procedures so that the children can help the parent make good decisions regarding medical care. Hereinafter, unless indicated otherwise, a person that has the authority to access another person's medical information will be referred to as a “proxy” and when the person accesses the other person's account the access will be referred to as “proxy access”.

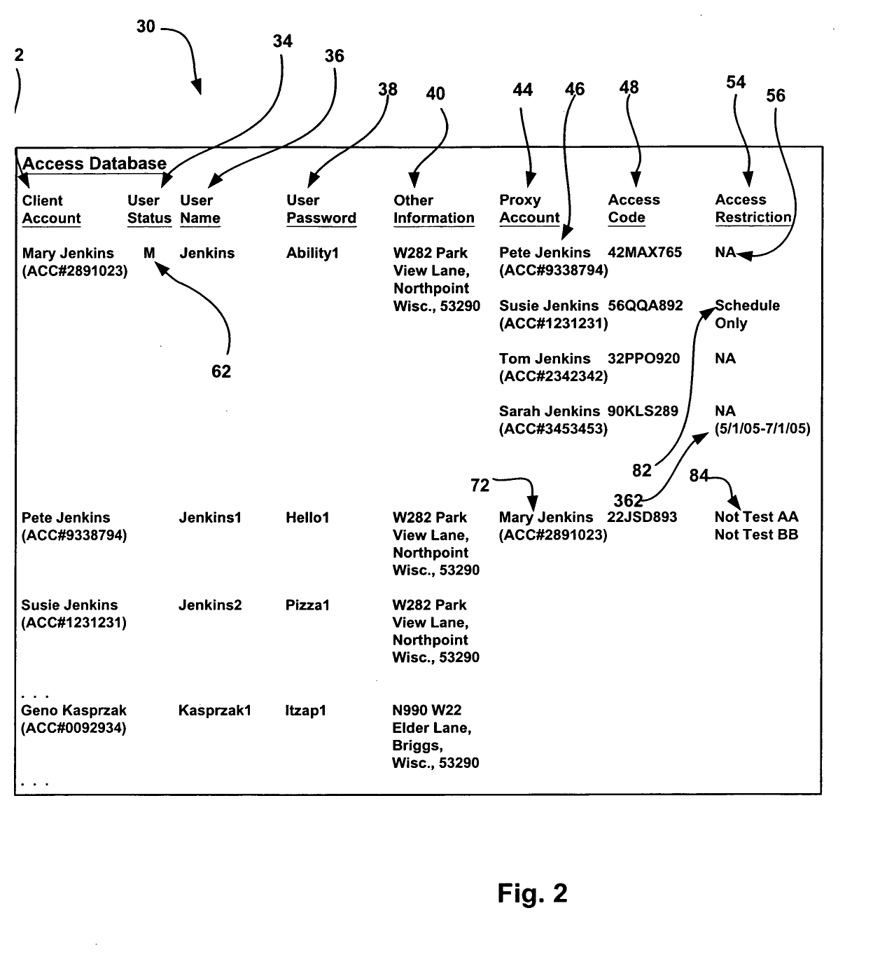

Referring still to FIG. 1, access database 30 stores information regarding proxy authority. Referring also to FIG. 2, an exemplary access database 30 consistent with at least some aspects of the present invention is illustrated. Among other columns, access database 30 includes a Client Account column 32, a “User Name” column 36, a “User Password” column 38, an “Other Information” column 40, a “Proxy Account” column 44 and an “Access Code” column 48. As the label implies, Client Account column 32 lists each one of the patients associated with St. Mary's Hospital that has a medical information account through which information is accessible via system 10. For example, among others, Mary Jenkins, Pete Jenkins, Suzie Jenkins and Geno Kasprzak are listed in column 32. In addition to listing the patients having accounts, column 32 also includes a unique client account number associated with each one of the clients listed. For example, account no. 2891023 is associated with Mary Jenkins, account no. 9338794 is associated with Pete Jenkins, account no. 1231231 is associated with Suzie Jenkins, and so on.

Referring still to FIG. 2, User Name column 36 lists a separate user name for each one of the clients in column 32. For instance, “Jenkins” is the user name listed for Mary Jenkins in column 32, while user names “Jenkins1” and “Jenkins2” are indicated in column 36 for each of Peter Jenkins and Suzie Jenkins, respectively. User Password column 38 includes a separate password for each one of the user names in column 36. For example, password “Ability1” is associated with Mary Jenkins user name “Jenkins” while password “Hello1” is listed as the password corresponding to Pete Jenkins user name “Jenkins1”. Here, when a system user enters one of the user names/password combinations indicated in columns 36 and 38, the user is provided access to the associated account in column 32. For example, referring also and again to FIG. 1, when a user enters the user name “Jenkins” and password “Ability1” via a browser page provided on display 21, server 12 accesses database 30 and uses that name and password combination to identify Mary Jenkins account number 2891023 and then facilitates access to Mary Jenkins' account.

Referring still to FIG. 2, the Other Information column 40 includes other information for each one of the clients listed in column 32. Here, the exemplary other information includes a residential address at which the associated client resides. For example, the address for each of Mary Jenkins, Pete Jenkins and Suzie Jenkins is listed in column 40 as “W282 Park View Lane, Northpoint, Wis. 53209 while the address for Geno Kasprzak is different. While addresses have been listed in column 40, it should be appreciated that other additional and different types of information are contemplated that may be listed. For instance, familial relationships may be indicated in column 40 such as, for Suzie Jenkins, identifying Mary Jenkins and/or Pete Jenkins as a guardian, for Pete Jenkins, identifying Mary Jenkins as a spouse, for Geno Kasprzak, identifying Mary Jenkins as a legal guardian, etc. These relationships may be used to formulate rules to allow the automatic granting of proxy access.

Referring once again to FIG. 2, Proxy Account column 44 lists, for at least a sub-set of the clients listed in column 32, one or more other facility clients (e.g., patients) that the client is a proxy for (i.e., for which the client has proxy access authorization). For example, for Mary Jenkins in column 32, column 44 lists each of Pete Jenkins, Suzie Jenkins, Tom Jenkins and Sarah Jenkins which indicates that Mary Jenkins has proxy access authorization and has the ability to access at least some record information for each of Pete, Suzie, Tom and Sarah Jenkins. Similarly, for Pete Jenkins in column 32, column 44 lists Mary Jenkins indicating that Pete Jenkins has proxy access authorization to access at least some records or information associated with Mary Jenkins. In addition to listing persons in column 44, column 44 also includes an account number for each one of the persons listed. For instance, Pete Jenkins account no. 9338794 is listed along with Pets Jenkins name in column 44, Suzie Jenkins account no. 1231231 is listed along with Suzie Jenkins name is column 44, etc.

Referring yet again to FIG. 2, Access Code column 48 lists a separate eight character access code for each one of the proxy's listed in column 44. For instance, access code “42MAX765” is listed in column 48 for the proxy account associated with Pete Jenkins in column 44 for client Mary Jenkins in column 32. Similarly, access code “56QQA892” is listed in column 48 for the proxy account associated with Suzie Jenkins in column 44 for client Mary Jenkins in column 32. As one other example, access code “22JSD893” is listed in column 48 for the proxy account associated with Mary Jenkins in column 44 for client Pete Jenkins in column 32.

Here, referring once again to FIGS. 1 and 2, it is contemplated that, after Mary Jenkins has accessed her client account by entering her user name and password combination via computer 20, in addition to being able to access her own medical records, scheduling information, etc., server 12 will also allow Mary Jenkins to access information for any one of the proxy accounts listed in column 44 by entering the associated access code in column 48 via a field provided on display 21. For instance, to access medical records or scheduling information for Suzie Jenkins, when prompted Mary Jenkins enters access code 56QQA892 (see again column 48). Once the proper access code has been entered, server 12, in at least some embodiments of the present invention, allows Mary Jenkins to access the same information and in the same format that Suzie Jenkins is authorized to access when Suzie Jenkins is logged onto her own client account. Here, for instance, when Mary Jenkins accesses Suzie Jenkins account from within Mary Jenkins account, a separate browser type window may be opened on display 21 in which Suzie Jenkins account is presented.

In at least some embodiments of the present invention it is contemplated that any or at least a subset of the patients that have client accounts supported by system 10 of FIG. 1 may be able to, via interface 20, quickly and easily and without help from a facility system employee or administrator, grant proxy access authorization to some other facility client. For instance, referring again to FIG. 2, assume that initially Pete Jenkins is not authorized to access records or scheduling information for Mary Jenkins and hence the Mary Jenkins designation 72 in column 44 initially is not present. Also assume that Mary Jenkins wishes to grant her husband Pete proxy access authorization.

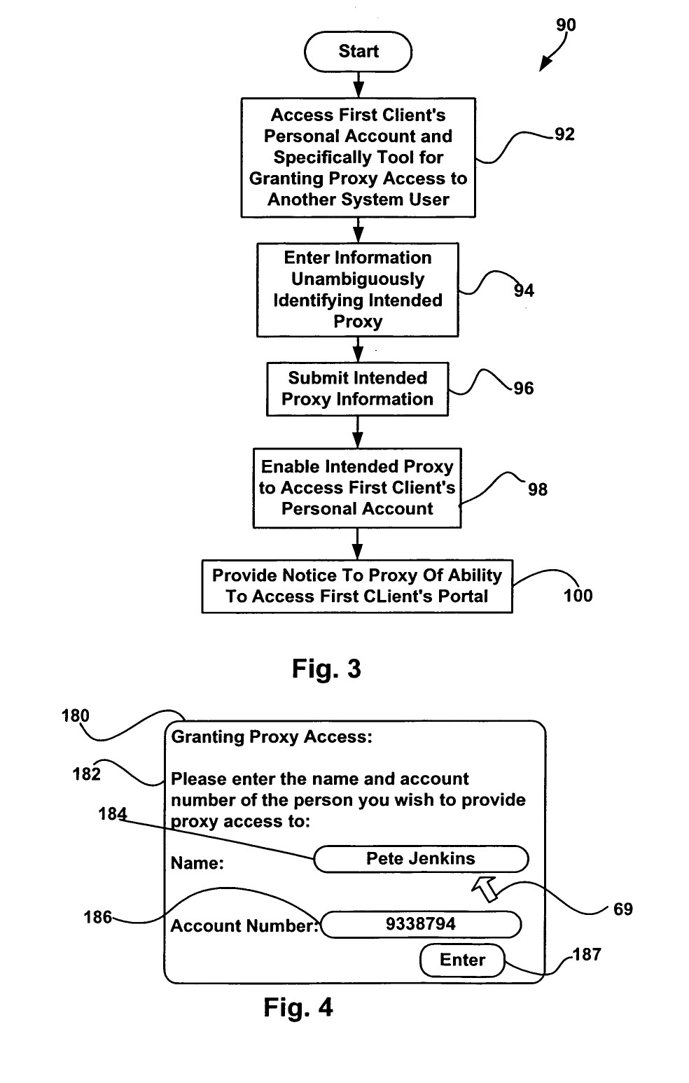

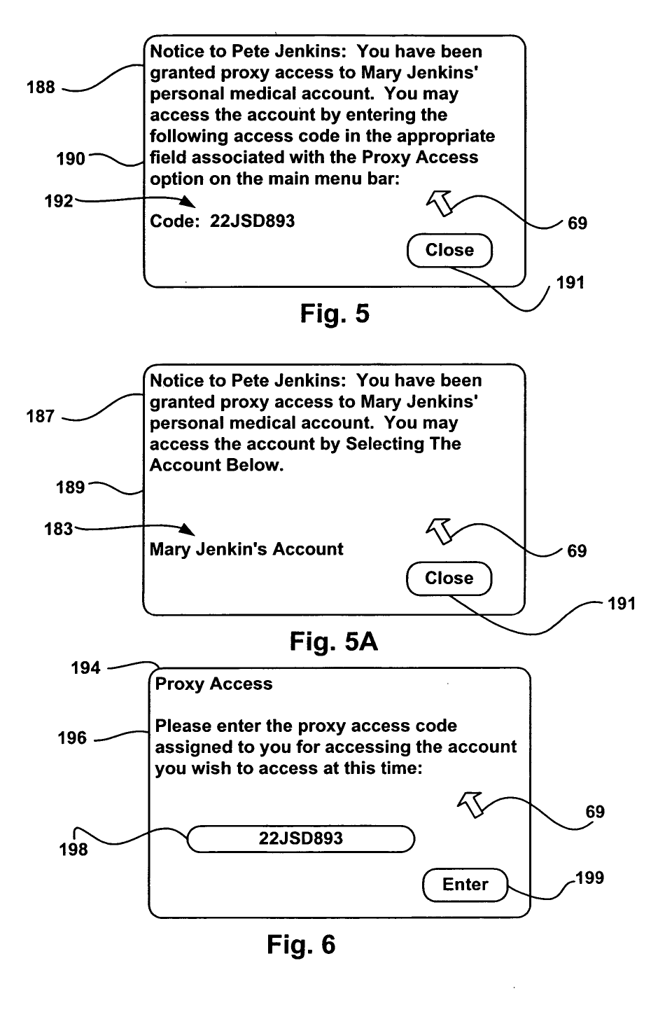

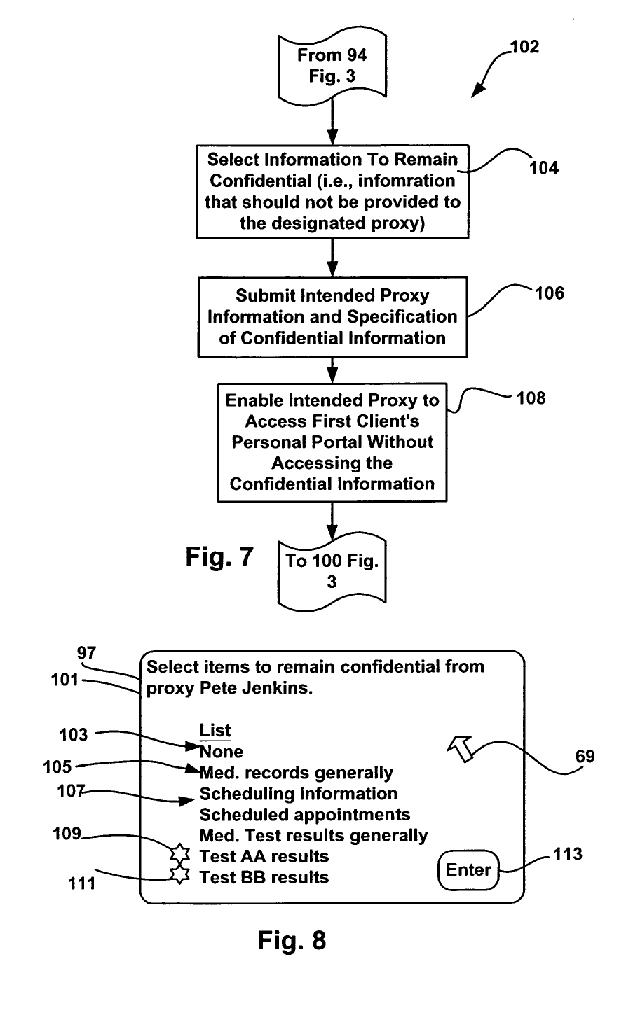

Referring now to FIG. 3, an exemplary process 90 that may be facilitated by system 10 of FIG. 1 whereby Mary Jenkins grants proxy access authorization to her husband Pete Jenkins is illustrated. Beginning at process block 92, Mary Jenkins accesses her medical information account by entering her user name and password combination. Upon accessing her account, server 12 may provide Mary Jenkins with a home browser window for her account like the window 400 illustrated in FIG. 20 that includes a list 402 of information and management tool options for Mary's account. Here, among other options, list 402 includes a “Grant New Proxy Access” option 404. In at least some embodiments it is contemplated that each option in list 402 will be hyperlinked to an associated additional browser page or will cause an additional browser associated therewith to be opened when selected. Here and throughout this specification, it will be assumed that hypertext (i.e., selectable text linked to other browser pages and additional related information) or icons presented on a display screen 21 (see FIG. 1) is selectable by moving a cursor 69 that is controlled by mouse 25 (see again FIG. 1) to a location over the text and then performing a selection activity such as double clicking one of the mouse buttons. Similarly, it will be assumed that a cursor can be used to select a field (e.g., see 184 in FIG. 4) provided in a window for entering information in the field. In the present example, to grant new proxy access to Pete, Mary selects option 404.

Referring also to FIG. 4, an exemplary window 180 for granting new proxy access is illustrated which includes, among other things, instructions 182 for entering the name of the client to which Mary wants to grant proxy access as well as the medical information account number assigned to the client to which Mary wants to grant proxy access. Here, it is assumed that the client to which Mary is granting proxy access will be able to provide his account number to Mary to set up the proxy access authorization. In addition to instructions 182, window 180 includes a name field 184 and an account number field 186 for entering the name and account number of the client to which Mary wished to provide proxy access. An ENTER icon 187 is provided for submitting information entered in fields 184 and 186 to server 12.

At block 94 in FIG. 3, Mary enters the information that unambiguously identifies her husband Pete (e.g., name and account number) as the intended proxy and at process block 96 Mary selects icon 187 to submit the name and account number specified in fields 184 and 186 to server 12.

Continuing, at block 98, server 12 enables the specified client (i.e. Pete in the present example) to access Mary's account. Referring once again to FIG. 2, access is enabled in the present example by adding Mary Jenkins and her account number 2891023 (see again 72) to column 44 of database 30 as well as generating and storing access code 22JSD 893 in column 48.

In addition to specifying proxy access information in database 30, in at least some embodiments, server 12 transmits a notice to Pete Jenkins indicating that proxy access to Mary Jenkins medical information account has been granted and how to access that account. In FIG. 3, the step of providing notice to the proxy is indicated via process block 100. Referring also to FIG. 5, an exemplary notice window 188 that may be provided to Pete Jenkins the next time he accesses his medical information account via computer 20 is illustrated including notice text and accessing instructions 190, an access code 22JSD893 to be used to access Mary's account and a CLOSE icon 191 for closing the window 188. Other types of notices are contemplated including e-mail, voice mails, electronic paging messages, etc.

Referring to FIG. 5A, another exemplary notice window 189 is illustrated that includes a notice 187 to Pete Jenkins that proxy access has been granted and that also includes hypertext “Mary Jenkins' Account” 183 that is selectable to immediately access Mary's account.

Referring again to FIG. 20, after Mary has granted Pete proxy access, when Pete Jenkins accesses his account, Pete can access Mary's account by selecting an “Access Another Account” option 406 from the main or home menu option list 402. When option 406 is selected, referring also to FIG. FIG. 6, an exemplary proxy access window 194 may be presented via display 21. Window 194 includes instructions 196 to enter the proxy access code along with a field 198 for entering the access code and an ENTER icon 199. After a code has been entered into field 198, the user selects ENTER icon 199 to submit the code to server 12 and thereby gain access to the other client's account if the user is authorized to proxy access the other account.

While the example above and described with respect to FIGS. 3 through 6 has been described in the context of one client of St. Mary's Hospital granting proxy access to another client, in at least some cases it is contemplated that a facility client may want to grant proxy access to someone other than a facility client or other entity that already has a client account supported by system 10. To this end, according to a process similar to that described with respect to FIG. 3, a patient may grant proxy access to a third party that does not currently have an account supported by system 10 by, at process block 94, providing some other type of unambiguous information for identifying the third party to be granted access. For instance, if Mary Jenkins wanted to grant her insurance company proxy access, at block 94, Mary may enter an insurance company identification code or something akin thereto to grant access. Thereafter, at block 98, where proxy access is enabled, the enabling step would include, in at least some cases, when a representative from the insurance company accesses a browser page provided by server 12, opening of a new client account, this time associated with the insurance company, where the account includes a proxy access option. Once the new account is opened, a notice akin to the notice illustrated in FIG. 5 may be provided to an employee of the insurance company giving instructions to access Mary's account.

In at least some cases it is contemplated that, while a client may wish to grant a third party access to at least some medical scheduling information, the client may wish to restrict access or prohibit access to other information. For instance, while Mary Jenkins may want her husband Pete to be able to access all of her medical records information, Mary may not want Pete to have the ability to schedule appointments for her. Similarly, while Suzie Jenkins may want her mother Mary to be able to schedule appointments for her, Suzie may not want her mother to be able to access the results of medical tests. As still one other example, while Mary Jenkins may want her husband Pete to be able to either schedule appointments for her or to see general types of medical records, Mary Jenkins may not want her husband to be able to see the results of two tests she had performed including tests AA and BB.

According to another aspect of the present invention, in addition to enabling a system user to grant proxy access to a third party, the user may also be able to either identify specific categories of information such as, for instance, scheduling information, test results, etc., that should not be provided to a proxy or, to identify specific events or test results that should to be provided to the proxy, all unspecified information remaining completely confidential. In this regard, an exemplary sub-process 102 that may be substituted for a portion of the process illustrated in FIG. 3 is illustrated in FIG. 7. Referring also to FIG. 3, after block 94, control passes to block 104 where the client selects information that is to remain confidential. Here, any of several different types of tools for selecting information to remain confidential may be employed. One exemplary tool is illustrated in FIG. 8 as a window 101 that includes instructions 97 for selecting items from a list of items to remain confidential, a list and an ENTER icon 113 for submitting items selected from the list. Here, the list includes, among other entries, a “None” entry 103 that, when selected, indicates that none of the information should be maintained confidential. The list also includes a “Medical Records Generally” entry 105, a “Scheduling Information” entry 107, a “Test AA Results” entry 109, a “Test BB Results” entry 111, and so on. In this example, when one of the items or entries in the list is selected, an icon indicating selection thereof is provided to the left of the item. Two exemplary icons are identified by numerals 109 and 111 in FIG. 8. After all of the items to remain confidential have been selected, ENTER icon 113 is selected to submit the list to server 12. In the present example, window 97 of FIG. 8 is provided after ENTER icon 187 has been selected in window 180 (see again FIG. 4).

Referring once again to FIG. 7, at block 106, the information to remain confidential is submitted to server 12 and at block 108 the proxy is granted access to the client's account without allowing access to the confidential information. Here, after the proxy information is submitted at block 106, restriction information associated therewith is used to instantiate an entry in an additional access restriction column 54 as illustrated in FIG. 2. For instance, where Mary Jenkins indicates that the results of tests AA and BB should remain confidential from her husband Pete, information 84 indicating the restriction is provided in column 54. Similarly, where Suzie Jenkins indicates that her mother Mary should only be able to schedule appointments for her and should not be able to access Suzie's medical history records, information 82 indicating this restriction is added to column 54. An “NA” designation 56 in column 54 indicates that there is no restriction on proxy access. After block 108 in FIG. 7, control passes back to 100 in FIG. 3.

As indicated above, instead of allowing a client to select information that should remain confidential, in at least some embodiments it is contemplated that server 12 instead request that the client identify information that should be shared with a proxy. This version of the system is advantageous as it requires the client to think more critically about the type of information being shared with a proxy. Furthermore, this version allows a client/patient/person to easily grant access to a very limited subset of their data. In at least some cases the client may be forced to individually identify each separate item to be shared while in other cases the client may only be required to identify general groups of information types (e.g., symptoms, tests performed, test results, etc.). In either of these two cases, a list akin to the list illustrated in FIG. 8 may be provided to select a subset of information to be shared when submitted to server 12 via selection of an entry icon similar to icon 113.

Here it should be noted that where medical information is stored in small record sections or subfiles as described above and where records are formed by cobbling together the subfiles when specific record types are requested, ability to restrict access to specific information types is greatly enhanced. Similarly, in a system using a relational database structure and universal patient record, the ability to grant or restrict access to specific subsets of information is greatly improved and simplified. For instance, where a complete record of a specific type includes twenty fields, it is conceivable that a client could restrict access to any subset of the field information in the manner described above instead of simply restricting access to information in all twenty fields. For example, where two of the fields specify a physician that performed a test and results of the test, those two fields may be restricted while the other eighteen fields are left unrestricted. Thus, the file and information formats are particularly important in at least some inventive embodiments for facilitating meaningful restrictive access options.

In at least some embodiments it is contemplated that a first facility client that has a special relationship with a second facility client may want to obtain access to the second client's medical records or scheduling information independent of whether or not the second client formally grants proxy access to the first client. For instance, Mary Jenkins may, under the law and pursuant to rules enforced by St. Mary's Hospital, be authorized to access medical records and scheduling information for her son Tom if Tom is a minor (e.g., where Tom is less than 16 years old in at least some jurisdictions). Further, Mary's access may be limited by medical privacy laws of the jurisdiction in which St. Mary's Hospital is located (e.g., full access may be granted for a ten year old buy only partial access may granted for sixteen year old). As another instance, St. Mary's Hospital may have a general rule that anyone that lives at the same residence and that has the same last name as a first account owner may be able to access the first account owner's account. In these cases it is contemplated that server 12 may be programmed to grant proxy access to a first client that has a special relationship with a second client if the first client requests access and independent of whether the second client grants access.

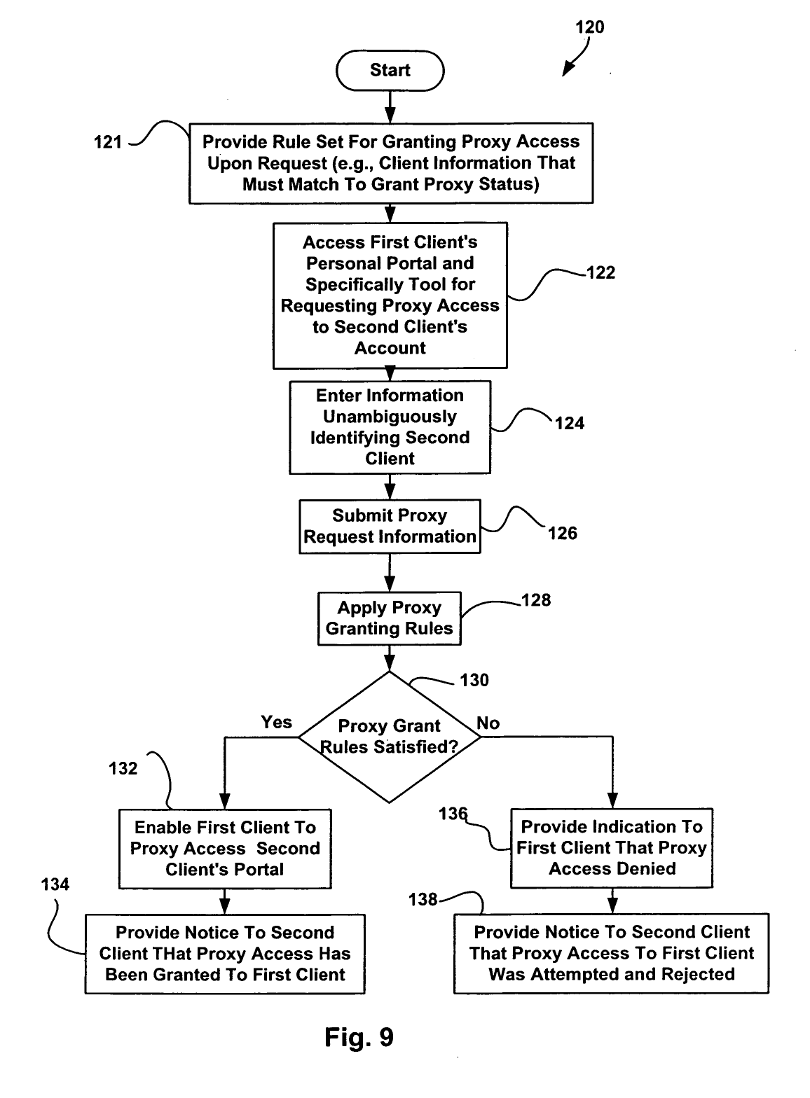

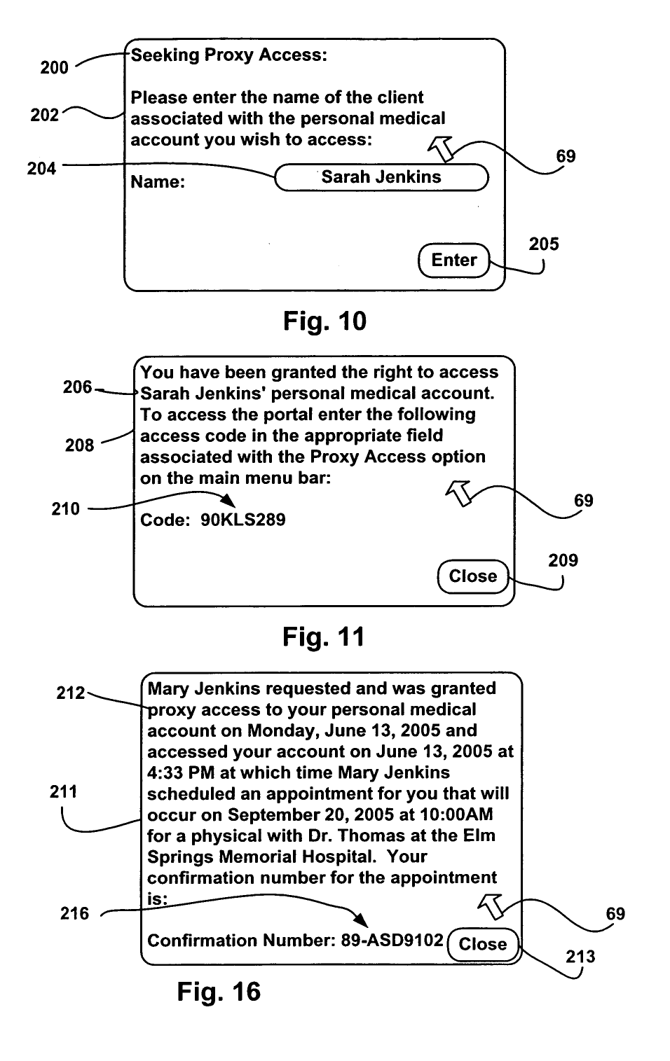

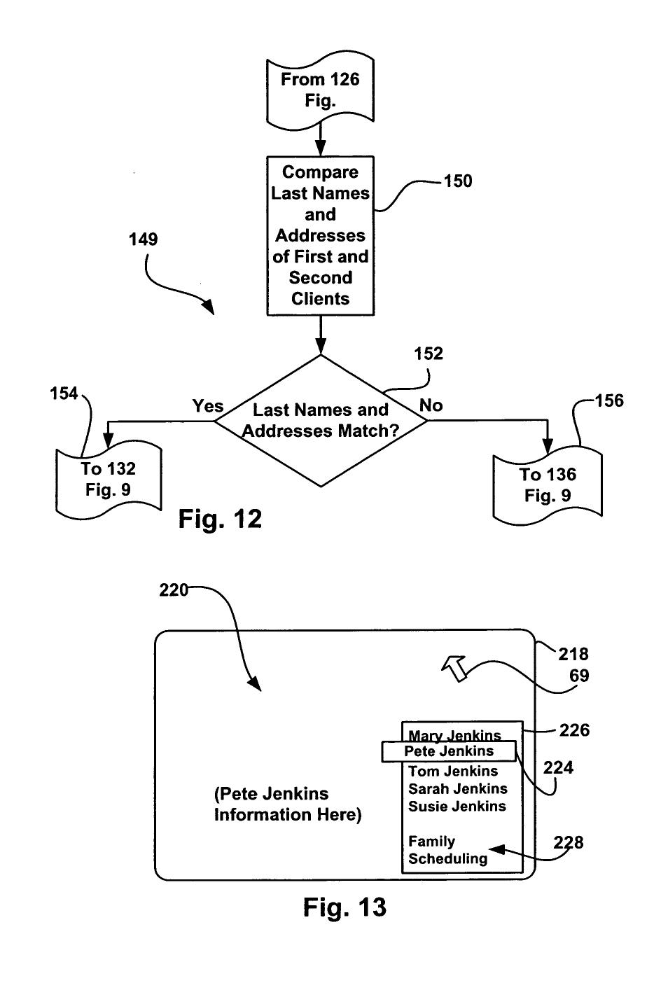

For the next example, referring again to FIG. 2, assume that initially Mary Jenkins does not have proxy access authority to access Sarah Jenkins medical information account and therefore that Sarah Jenkins 74 is not listed in column 44. Referring also to FIG. 9, a method 120 whereby Mary Jenkins can seek and obtain proxy access to Sarah Jenkins' account is illustrated. Beginning at block 121, rules are specified for granting proxy access upon request and are stored by server 12 in database 14. Next, at block 122, Mary Jenkins accesses her own medical information account by entering her user name and password combination and submitting that information to server 12. Thereafter, Mary is again provided with the home browser window 400 illustrated in FIG. 20 where a “Request Proxy Access” option 408 is included in list 402. After option 408 is selected, referring to FIG. 10, an exemplary window 200 for seeking proxy access may be opened that includes instructions 202, a name field 204 and an “ENTER” icon 205.

Referring still to FIGS. 1, 9 and 10, at block 124, Mary enters information that unambiguously identifies Sarah Jenkins. In the present example, Mary enters Sarah's name. At block 126, Mary selects ENTER icon 205 to submit the proxy request information to server 12. At block 128, server 12 applies the proxy grant rules. At block 130, where none of the proxy grant rules have been satisfied, control passes to block 136 where server 12 provides an indication to Mary that proxy access has been denied. In at least some cases it is contemplated that, whenever a first client requests proxy access to a second client's information and that request is denied, a notice is provided to the second client. To this end, after block 136, control passes to block 138 where notice is provided to the second client that proxy access was attempted by the first client and rejected.

Referring once again to block 130, where at least one of the proxy grant rules has been satisfied, control passes to block 132 where server 12 enables proxy access to Sarah Jenkins' medical information account. To enable proxy access, consistent with the example and referring again to FIG. 2, Sarah Jenkins and her account number are added to proxy column 44 associated with Mary Jenkins in column 32 and an access code 90KLS289 is added to column 48. In addition, in at least some embodiments, a notice may be provided to Mary at block 132 indicating that access has been granted along with instructions for accessing Sarah Jenkins' account. To this end, FIG. 11 includes a notice window 206 indicating access has been granted and providing instructions for access 208 identifying access code 90KLS289 (see 210) and including a CLOSE icon 209 selectable to close the window 206.

Referring still to FIG. 9, in at least some cases, when access is granted to Mary, a notice is provided to Sarah via Sarah's account indicating that access has been granted to Mary. This notice providing step is identified by numeral 134 in FIG. 9.

Referring now to FIG. 12, an exemplary sub-process that may be substituted for a portion of the process illustrated in FIG. 9 is shown where the proxy granting rule set requires that the last names of first and second clients as well as the residential addresses of the first and second clients have to be identical in order for a first client to seek and obtain access to the second client's information automatically. Referring also to FIG. 9, after block 126, control passes to block 150 in FIG. 12 where server 12 compares the last names and addresses of the first and second clients. In the present example, server 12 compares Mary's and Sarah's last names as well as their residential addresses. At block 152, where the names and addresses do not match, control passes back to block 136 in FIG. 9 where the method described above continues. Referring once again to block 152, where the last names and addresses do match, control passes back block 132 in FIG. 9 where the process continues. Here it should be appreciated that the proxy grant rules may take many different forms and may be based on many different types of information. In most cases, however, the rules should be based on at least semi-permanent information such as last names, addresses, birth dates and familial records, etc., so that the rules can be suitably applied.

While the embodiments described above have many advantages over known prior art systems, it has been recognized that there are cases wherein one person is often responsible for medical activities associated with a group of people. For example, in many cases, a parent will be responsible for medial activities for each of her children as well as for another parent. Where a parent is responsible for medical activities for children and another parent, while proxy access enables the patent to review medical information for each one of the children and the other parent as well as to schedule appointments for each of the children and the other parent, using separate client accounts for each one of the children, the parent and the other parent is tedious.

For instance, in the exemplary case above, if Mary Jenkins has to schedule doctor's appointments for each of her children as well as for her husband and herself within a two week period and would prefer to schedule all of those appointments so that they occur on the same day and generally simultaneously or at least consecutively, Mary would have to access five different client accounts to schedule the appointments. In addition to the fact that flipping between accounts and accurately remembering and entering access codes would be tedious, coordinating times and physicians for all five appointments would be cumbersome. For instance, after Mary schedules appointments for Sarah and Tom at 9:00 a.m. and 9:30 a.m. as well as for Pete at 10:00 a.m. on a particular Thursday morning, when Mary accesses Sarah's account to schedule an appointment with a specific physician, Mary may realize that the specific physician's schedule is completely full on the Thursday morning. In this case, Mary would have to attempt to reschedule all of the five appointments at some other time to make appointments on the same day. This iterative process of scheduling and rescheduling would be cumbersome, difficult and subject to errors.

To deal with the problems associated with attempting to schedule appointments for multiple persons using multiple accounts, according to at least some embodiments of the present invention, it is contemplated that any proxy may be designated as a “manager”. Here, a manager designation may be used by server 12 automatically identify a subset of clients for which another client should be granted proxy access and then may automatically grant that proxy access and, in effect, push that proxy access off to the managing client. For instance, in the present example, where Mary Jenkins is designated as the manager for her family, server 12 may automatically identify each member of her family (e.g., by matching last names and residential addresses) and then may provide a list of members of Mary's family whenever Mary logs on to her medical information account where each entry in the list is hyperlinked to the specific member's client account. In this example, to flip from one family member's account information to another, instead of having to go through the proxy access requesting screens and having to enter the separate account access codes, Mary could simply select one of the family members accounts from the list presented.

Referring once again to FIG. 2, an additional column, a User Status column 34, is provided in database 30 where an “M” designation (see, for instance 62) indicates that a user associated therewith in column 32 is a manager for all of the clients listed in proxy column 44. Note here that Mary Jenkins is identified by designator 62 as a manager while neither Pete nor Suzie is identified as a manager.

Referring now to FIG. 13, in at least some embodiments, it is contemplated that where a client is a manger for other clients, irrespective of the information being currently examined by the manager via the manager's account, a client list may be provided within a box 226 that separately identifies each client that the manager manages for. In the present case, consistent with the example above, each of Mary, Pete, Tom, Sarah and Suzie Jenkins is listed in box 226. To select one of the accounts associated with the persons listed in box 226, Mary uses mouse 25 (see FIG. 1) to move icon 69 to a position to select the specific person and then selects that person (e.g., may double click on the person's name). When one of the persons in the list is selected, the persons name in the list is highlighted in some fashion. In the illustrated example, Pete Jenkins is selected and his name is highlighted by placing a box 224 there around in the list. When one of the people in the list is selected, that person's account is opened within window 218 and information associated therewith is displayed in space 220.

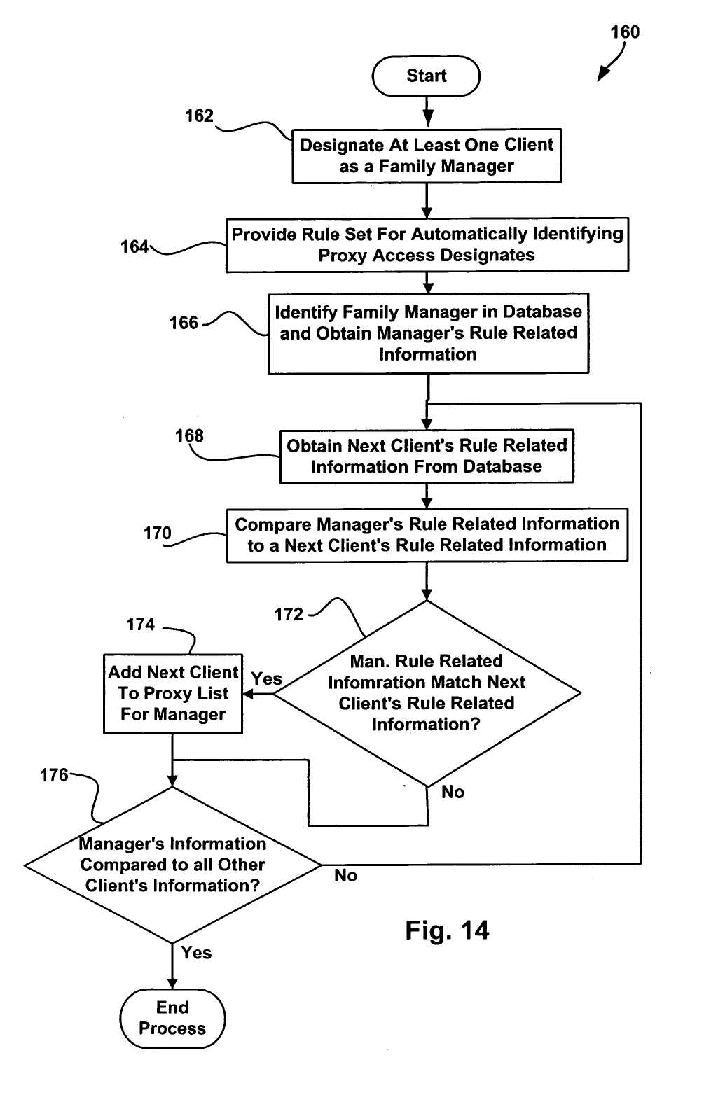

Referring now to FIG. 14, an exemplary method 160 for identifying clients for which proxy access should automatically be granted to specific managers is illustrated. Beginning at process block 162, at least one client is identified as a manager. In the present example, Mary Jenkins is identified as the client manager at block 162. At block 164, a rule set is specified for automatically identifying proxy access designates (i.e., clients for which proxy access will automatically granted to another client base on the rules). For instance, one rule consistent with the example above may be that designates must have the same last name and residential address as a manager for proxy access to automatically be granted to the manager.

Next, at block 166, server 12 identifies a family manager in the database (see again FIG. 2) and obtains the manager's rule related information. Again, in the present example, server 12 would identify Mary Jenkins as a manager and would obtain her last name as well as her residential address. At block 168, processor 12 obtains a next clients rule related information from the database. In the present case, server 12 identifies Pete Jenkins as the next client and obtains Pete's last name and residential address from database 30. At block 170, processor 12 compares Mary's and Pete's rule related information. At block 172, where Mary and Pete's rule related information is different, control passes to block 176 where server 12 determine whether or not Mary's rule related information has been compared to all other client's rule related information. Where Mary's rule related information has been compared to other client's rule related information, process 160 ends. Referring still to block 176, where Mary's rule related information has not been compared to all other client information, control passes back up to block 168 where the next client's related information is obtained from database 30.

Referring once again to decision block 172, where Mary's rule related information matches the next client's information, control passes to block 174. In the current example, Mary's rule related information would match Pete's rule related information (i.e., the last names and residential address information is identical) and therefore control passes to block 174. At block 174, server 12 adds the next client to the proxy list for the manager. In the present example, Pete Jenkins is added to the proxy list for Mary Jenkins along with a corresponding access code 42MAX765 (see again FIG. 2). After block 174, control passes to block 176. The process including blocks 168, 170,172,174 and 176 continues until all of the clients' rule related information has been compared to Mary Jenkins' information. Process 160 is repeated for each of the clients in database 30 that is identified as a manager in column 34.

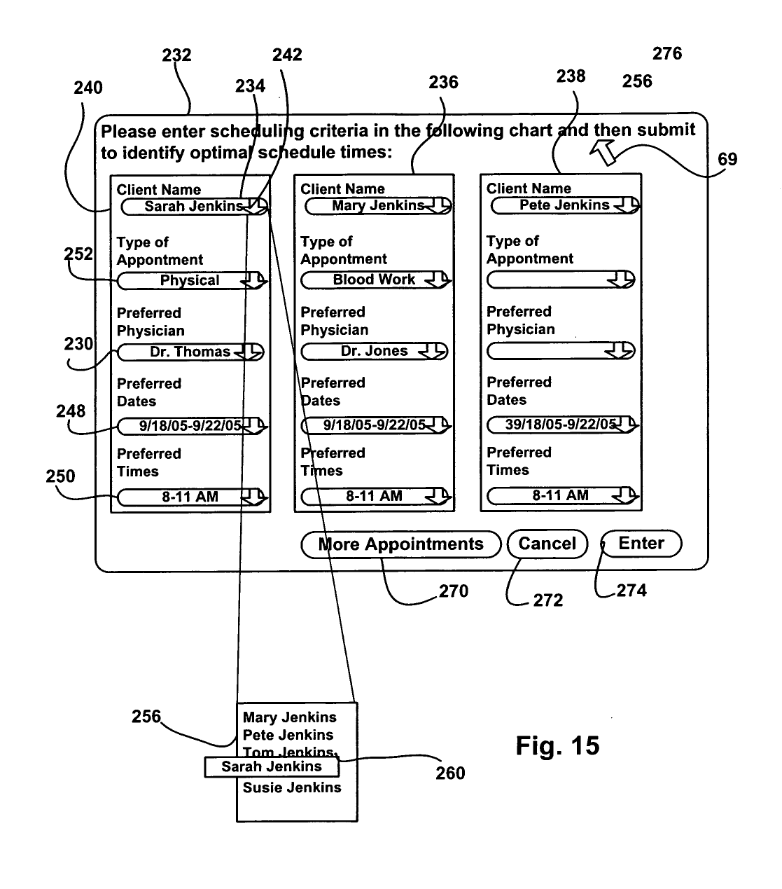

Referring once again to FIG. 13, in addition to listing each family member in block 226, a “Family Scheduling” designation 228 is provided in box 226. When designation 228 is selected, in at least some embodiments of the present invention, tools are provided to allow a manager to schedule one or more appointments for one or more clients managed by the manager and to perform the appointment scheduling process in a streamlined and simplified fashion. To this end, an exemplary window 232 is illustrated in FIG. 15 which may be provided when designation 228 in FIG. 13 is selected.

Window 232 includes instructions for entering and submitting scheduling criteria as well as separate smaller scheduling windows 236, 238 and 240, a “MORE APPOINTMENTS” icon 270, a “CANCEL” icon 272 and an “ENTER” icon 274. Each of the smaller scheduling windows 236, 238 and 240 is similar and therefore only window 240 is described here in any detail. Window 240 includes a plurality of different fields including a client name field 234, a type of appointment field 252, a preferred physician field 230, a preferred dates field 248 and a preferred times field 250. Each of fields 234, 252, 230, 248 and 250 is suitable for entering text to specify information about a specific appointment to be scheduled. To help the manager schedule appointments, drop-down window arrows are provided, one identified by numeral 242 which, when selected, opens up a smaller window with possible information to be used to populate an associated field. For instance, when arrow icon 242 is selected, a small window opens including a list of the clients managed by Mary Jenkins in the present example from which one of the persons on the list can be selected to fill in information in field 234.

After information is filled in one of the smaller appointment windows, the manager can fill in a second, a third, and so on, small appointment window. Where additional appointments need to be made, the manager can select icon 270 to be provided with additional small scheduling windows like window 240. To cancel scheduling activity, the manager can select CANCEL icon 272. After appointment information has been specified via one or a plurality of windows 236, 238 and 240, ENTER icon 274 can be selected to submit the appointment specifications to server 12.

When server 12 receives appointment information corresponding to two or more clients, server 12 searches schedule information stored in database 14 for St. Mary's Hospital, identifies a subset of appointment times that meet the criteria specified, and the provides one or more options to the manager with the most optimal option indicated first followed by the next most optimal option, and so on.

In at least some embodiments it is contemplated that where a first client accesses a second client's account information, the second client may want system 10 to provide a notice to that second client indicating when the access occurred, which information was reviewed, if any action (e.g., scheduling) occurred, etc. In this regard, an exemplary window 211 is illustrated in FIG. 16 that may be provided to Sarah Jenkins after her mother Mary schedules an appointment for her as a proxy. Window 211 includes a notice that Mary Jenkins accessed Sarah's account indicating the time Mary accessed the account and the nature of the access along with a CLOSE icon 213 for closing window 211. More specifically, the nature of the access is indicated as accessing for scheduling activity. In addition, information regarding an appointment scheduled by Mary is provided to Sarah along with a confirmation number 216 that Sarah can use to confirm the appointment if desired.

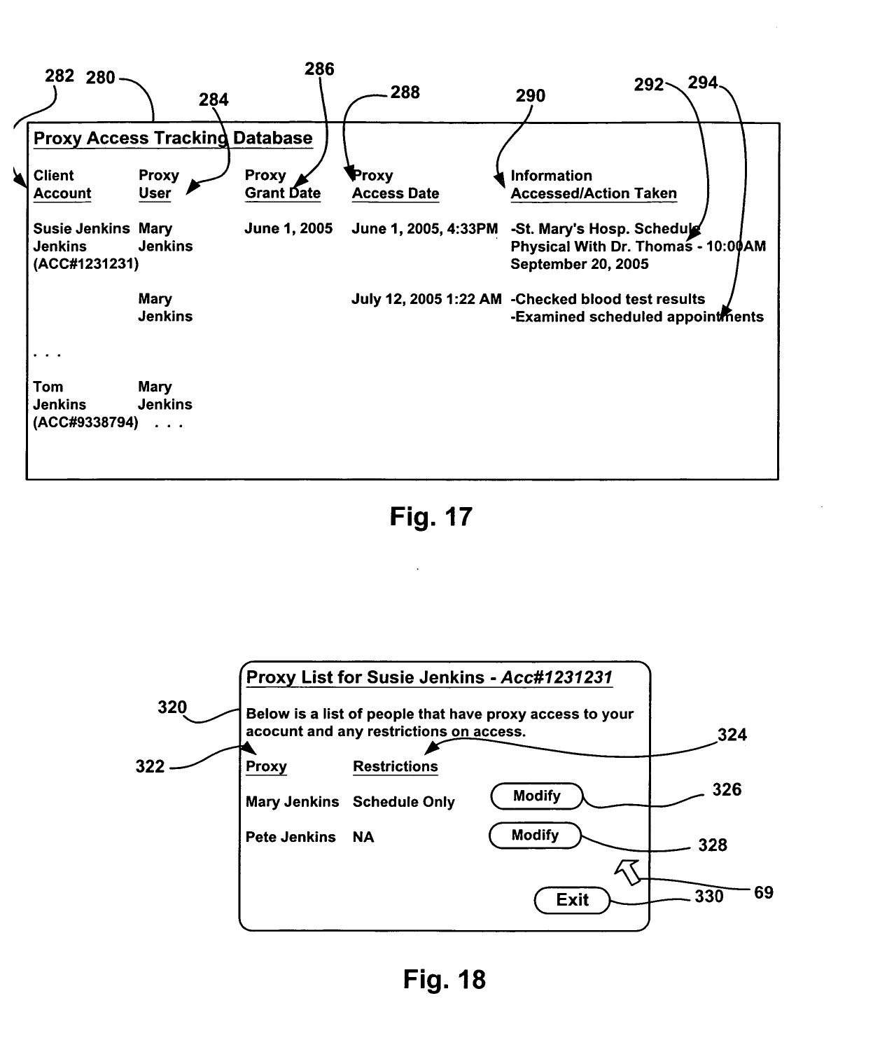

In at least some cases, it is contemplated that where a first client accesses a second client's account, the second client may want to subsequently review information regarding the access or, in the alternative, employees at the facility associated with system 10 may want to audit proxy access. To facilitate proxy access auditing, tracking database 280 is provided (see again FIG. 1), an exemplary tracking database illustrated in FIG. 17. Tracking database 280 includes a “Client Account” column 282, a “Proxy User” column 284, a “Proxy Grant Date” 286, a “Proxy Access Date” 288, and an “Information Access/Action Taken” column 290. Client Account column 282 lists each client having an account with the facility associated with system 10 (see again FIG. 1). In the example illustrated in FIG. 17, Suzie and Tom Jenkins are listed.

Proxy User column 284 lists a proxy user for each time proxy access is obtained for each client account in column 282. For example, Mary Jenkins is listed twice in column 284 for Suzie Jenkins' account in column 282 indicating that Mary Jenkins proxy accessed Suzie Jenkins' account twice. Mary Jenkins is listed once in column 284 for Tom Jenkins indicating that Mary Jenkins accessed Tom Jenkins' account once. Proxy Grant Date column 286 indicates the date on which proxy access was granted to the proxy user in column 284. For example, for Mary Jenkins, the proxy grant date for Suzie Jenkins is Jun. 1, 2005.

Proxy Access Date column 288 lists the date and time on which the proxy user in column 284 associated therewith accessed the client account in column 282. For instance, Mary Jenkins in column 284 accessed Suzie Jenkins' account in column 282 on Jun. 1, 2005 at 4:33 p.m. and accessed that same account on Jul. 12, 2005 at 1:22 a.m.

Information Accessed/Action Taken column 290 lists information accessed and actions taken for each one of the proxy access dates in column 288. For example, when Mary Jenkins accessed Suzie Jenkins' account on Jun. 1, 2005 at 4:33 p.m., column 290 indicates that Mary Jenkins accessed the hospital schedule and scheduled a physical with Dr. Thomas at 10:00 a.m. on Sep. 20, 2005. Similarly, on Jul. 12, 2005, at 1:22 a.m., Mary Jenkins accessed Suzie's account and checked Suzie's blood pressure results and examined Suzie's scheduled appointments. Many other entries in column 290 are contemplated.

With proxy access information stored in database 280 each time proxy access occurs, server 12 can allow St. Mary's Hospital employees or account owners to audit proxy access easily. For instance, referring again to FIG. 20, server 12 may provide a “Review Proxy Access” option 410 in home browser menu list 402 each time an account owner logs on to her account which, when selected, provides a list of recent or all proxy access instances along with information akin to the information stored in database 280.

To help an account owner determine who has proxy access and restrictions thereon, in at least some cases server 12 may be able to provide a list of proxies and to indicate restrictions imposed on each. For example, FIG. 18 illustrates one exemplary window 320 that lists proxies/restrictions for accessing Susie Jenkins' account. Window 320 includes a proxy column 322 and a restrictions column 324. In addition, window 320 includes separate “MODIFY” icons of 326 and 328 for each entry in column 322 and an “EXIT” icon 330. Icon 326 is selectable to modify the restrictions imposed on proxy Mary Jenkins while icon 328 is selectable to modify the restrictions imposed on proxy Pete Jenkins. Icon 330 is selectable to close window 320.

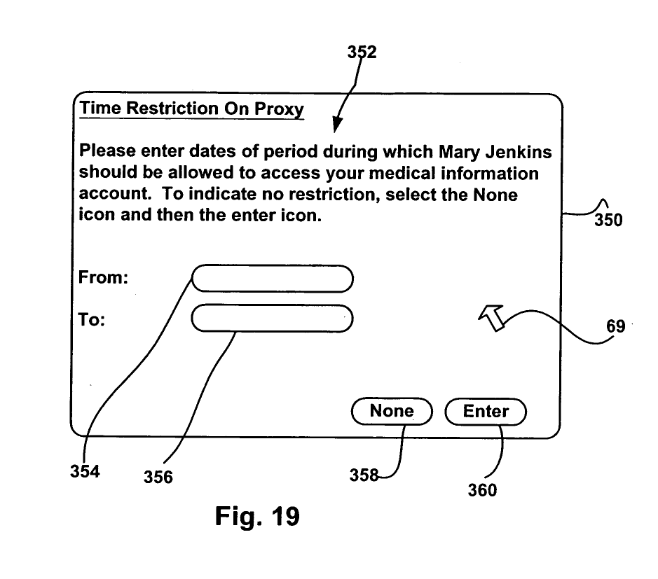

In at least some cases account owners may, in addition to wanting to be able to restrict information accessible to certain proxies, want to be able to restrict the duration of time of accessibility for one or all proxies. For instance, where Sarah Jenkins knows that she will be having a series of similar test procedures performed over the next several months, Sarah may want her mother Mary to be able to access her account only over the next two months and then to be prohibited from accessing thereafter. Here, in at least some embodiments, when Sarah is granting proxy access to Mary, a time restriction window may be provided to facilitate specification of a time restriction. For instance, after information to remain confidential has been selected via a window akin to window 97 in FIG. 8, another time restriction window 350 as illustrated in FIG. 19 may be opened including instructions 352 for setting a time restriction and tools (e.g., fields, buttons) for setting the restrictions. In FIG. 19, a “From” field and a “To” field are provided as well as a “NONE” icon and an “ENTER” icon 254, 256, 258 and 260, respectively. To specify a time restriction for proxy access, Sarah can enter dates in fields 254 and 256 and select icon 260. To indicate no time restriction on a proxy, “NONE” icon 258 can be selected followed by ENTER icon 260. Referring again to FIG. 2, when a time restriction is specified for a proxy, the restricted period is added by server 12 to column 54 under an associated content restriction indication. For instance, the period 5/1/05-7/1/05 is indicated at 362 which means Sarah has restricted Mary's access to Sarah's account to the two month period between May 1, 2005 and Jul. 1, 2005. After a time restriction has been specified, access to the restricted information is limited by server 12 to the specified time.

While the invention may be susceptible to various modifications and alternative forms, specific embodiments have been shown by way of example in the drawings and have been described above. However, it should be understood that the invention is not intended to be limited to the particular forms disclosed. For example, after a first client obtains proxy access to a second client's account, in at least some cases, where the first client retains authority to access the second client's account, the first client may always be provided with a proxy access window like window 226 in FIG. 13 that floats along on a display screen whenever the first client is accessing any client account. In addition, while various features and enhancements have been described above, it should be appreciated that each of the enhancements above and different subsets of the enhancements are considered novel. Moreover, while the example above allows a client to specify a time restriction generally for a specific proxy, in other contemplated embodiments different time restrictions may be settable for each of several different information types or information items. Furthermore, in addition to or instead of providing notice to a first client when a second client seeks proxy authority to access the first client's account or accesses the first client's account, notice may be provided to a system administrator for tracking purposes.

In addition, while the manager functionality has been described above in the context of the family where a mother acts as the family manager, the manager concept and related responsibilities may be applied to anyone within a family or, in some cases, to a person that is not formally or legally part of a family such as, for instance, a friend, legal guardian, a lawyer, a personal physician, etc., or anyone else that may access another's information and that would benefit from a streamlined access process.

Moreover, while the inventive concepts have generally been described above in context of systems that assign access codes to specific proxies in order to allow the proxies to access other client's information, in at least some cases it is contemplated that access codes would not be assigned and instead, whenever a proxy enters the proxy's own account, the proxy could, through the proxy's own account, access another client's account information without having to enter an access code. For instance, where the exemplary Peter Jenkins above is the legal guardian for an elderly family friend, Mr. Jenkins may obtain proxy access authority in any manner after which, when accessing his own account, Mr. Jenkins would be provided the capability to access the family friend's account information without requiring an access code. In some cases, for instance, Mr. Jenkins may simply enter the family friend's name into a field to specify the friend's account information. In other cases, the friend's name may be provided as hyperlinked text for quickly accessing the friend's account information. In this case, when Mr. Jenkins obtains authority access the friend's account information, a notice like the notice illustrated in FIG. 5 may be provided to Mr. Jenkins but, in this case, the code 192 would not be provided as no code is required.

Furthermore, in at least some embodiments when a first person obtains authority to access a subset of a second person's information as a proxy, the system may provide notice to the second person and allow the second person to either block access or to grant the right to access additional information even though the first person only initially sought the right to access the information subset. On-screen icons and tools and associated software for providing this functionality should be obvious to one of ordinary skill in the art in light of the teachings above.

In addition, in at least some embodiments a first person may want to grant authority to a second person to enter or submit information on behalf of the first person or a first person may want to seek authority to submit information on behalf of a second client. In these cases, methods are contemplated that are similar to the methods described above wherein client accounts are used to seek or grant authority to access information. Exemplary type of activities associated with submitting information on behalf of another person include but are not limited to allowing the second client to schedule appointments for the other person, order medications for the other person, enter patient related data on behalf of the other person, submit historical information related to the other person, fill out forms for the other person and submit medical questions to physicians on behalf of the other person.

Thus, the invention is to cover all modifications, equivalents, and alternatives falling within the spirit and scope of the invention as defined by the following appended claims. To apprise the public of the scope of this invention, the following claims are made:

What is claimed is:

1. A method for use with a computer network system including a server, a database and a plurality of interfaces wherein client medical information is stored in separate client accounts for each of a plurality of clients including at least a first client, the interface for accessing client account information, the method for authorizing a second client to access at least a portion of the first client's account information via one of the interfaces, the method comprising the steps of:
via one of the interfaces:
accessing the first client's account; and
via the first client's account, authorizing the second client to obtain at least a specific subset of the first client's account information; and
storing an indication in the database indicating that the second client is authorized to access the specific subset of the first client's account information.

2. The method of claim 1 further including the step of, after storing and when the second client accesses the second client's account, allowing the second client to access the specific subset of the first client's account information via one of the interfaces.

3. The method of claim 2 wherein the step of allowing the second client to access the specific subset includes providing an indication to the second client via the second client's account that the second client can access at least a portion of the first client's account information.

4. The method of claim 3 wherein the indication to the second client includes a hyperlink to the specific subset.

5. The method of claim 1 wherein a unique access code is associated with each of the client accounts and the step of authorizing the second client to access the specific subset of the first client's account information includes providing an access code associated with the second client's account via the first client's account.

6. The method of claim 5 wherein the step of accessing the first client's account includes providing the first client's account access code.

7. The method of claim 6 further including the step of, after storing, accessing the second client's account via one of the interfaces.

8. The method of claim 7 wherein the step of accessing the second client's account includes providing the second client's account access code.

9. The method of claim 2 wherein the step of allowing the second client to access the specific subset includes providing tools via one of the interfaces that allow other than the first client to request access to at least a subset of the first client's account information.

10. The method of claim 9 wherein the step of allowing the second client to access the specific subset of the first client's account information via one of the interfaces includes receiving a request via one of the interfaces from a requesting client other than the first client for the specific subset including information useable to identify the requesting client, determining if the requesting client is authorized to obtain the specific subset and, if the authorizing client is authorized to obtain the specific subset, providing the subset.

11. The method of claim 2 further including the steps of, after allowing access to the second client, monitoring the second client's access to the specific subset and, when the second client accesses the specific subset, storing information associated with the access.

12. The method of claim 11 wherein the step of storing information associated with the access includes storing the time of access and an indication of the information accessed.

13. The method of claim 2 further including the steps of, after allowing access to the second client, monitoring the second client's access to the specific subset and, when the second client accesses the specific subset, providing a notice to the first client that the subset of information has been accessed.

14. The method of claim 13 wherein the notice identifies the second client.

15. The method of claim 2 wherein the step of allowing the second client to access the specific subset includes providing a notice to the second client that the second client may access at least a portion of the first client's account information via one of the interfaces.

16. The method of claim 15 wherein the step of providing a notice includes one of transmitting an e-mail, providing a voice mail, transmitting a page and automatic creation/transmission of a letter.

17. The method of claim 1 wherein the specific subset is a first subset and wherein the step of authorizing the second client to obtain at least the specific subset of the first client's account information includes identifying at least a second subset of the client's account information that is different than the first subset wherein the second client is unable to access the second subset.

18. The method of claim 1 wherein the step of authorizing the second client to obtain at least a specific subset of the first client's account information includes specifying a period during which the second client is to be able to access the specific subset and the step of storing including storing the specified period.

19. The method of claim 18 further including the step of allowing the second client to access the specific subset during the specified period via one of the interfaces.

20. The method of claim 2 wherein the step of allowing access includes allowing the second client to enter information for storage.

21. The method of claim 2 wherein the step of allowing access includes allowing the second client to schedule appointments on behalf of the first client.

22. The method of claim 2 wherein the step of allowing access includes allowing the second client to send messages on behalf of the first client.

23. The method of claim 2 wherein the step of allowing access includes allowing the second client to enter medical information pertaining to the first client on behalf of the first client.

24. The method of claim 23 wherein the step of allowing the second client to enter medical information on behalf of the first client includes entering at least one of patient medical history information, medication renewal requests, patient-entered data flow sheets, completed medical questionnaires and fill-in forms.

25. The method of claim 20 further including the step of, after the second client enters information, providing a notice to the first client that is associated with the entered information.

26. The method of claim 1 further including the step of storing at least one rule useable to identify at least one first relationship between clients, the step of authorizing the second client to obtain at least a specific subset of the first client's account information including receiving an authorization indication, applying the at least one rule to determine if the at least a first relationship exists between the first and second clients, where the first relationship exists between the first and second clients, allowing access to the specific subset via one of the interfaces and, where the first and second client relationship is different than the first relationship, prohibiting access to the specific subset to the second client.

27. A method for use with a computer network system including a server, a database and a plurality of interfaces wherein client medical information is stored in separate client accounts for each of a plurality of clients, the interfaces for accessing client account information, the method for facilitating client access to other client information, the method comprising the steps of:
storing at least one rule useable to identify at least a first relationship between clients;
accessing a first client's account via one of the interfaces;
via the first client's account, indicating a desire to access at least a specific subset of a second client's account information;
applying the at least one rule to determine if the at least a first relationship exists between the first and second clients; and
where the first relationship exists between the first and second clients, allowing access to the specific subset of the second client's account information via the first interface.

28. The method of claim 27 wherein the at least one rule that is stored specifies at least one of a parental relationship, a guardian relationship, a guarantor relationship and a common address for the first and second clients.

29. The method of claim 27 further including the step of, after the first client's account is accessed, providing an interface tool for identifying the second client.

30. The method of claim 29 further including storing client information associated with each client that has a client account and wherein the step of applying the at least one rule includes accessing the client information for at least one of the first and second clients and analyzing the information to determine if the at least a first relationship exists between the first and second clients.

31. The method of claim 27 further including the steps of, after allowing access to the first client, monitoring the first client's access to the specific subset and, when the first client accesses the specific subset, storing information associated with the access.

32. The method of claim 31 wherein the step of storing information associated with the access includes storing the time of access and an indication of the information accessed.

33. The method of claim 27 further including the steps of, after allowing access to the first client, monitoring the first client's access to the specific subset and, when the first client accesses the specific subset, providing a notice to the second client via the second client's account that the subset of information has been accessed.

34. The method of claim 33 wherein the notice identifies the first client.

35. The method of claim 27 wherein, when other than the first relationship exists between the first and second clients, the method further includes the step of providing a notice to the second client that another client attempted to access at least a subset of the second client's account information.

36. The method of claim 35 further including the step of, when the notice is provided to the second client, allowing the second client to authorize the access sought by the first client.

37. The method of claim 27 wherein, when other than the first relationship exists between the first and second clients, the method further includes the step of providing a notice to a system administrator indicating that an unauthorized attempted access occurred.

38. The method of claim 27 further including the steps of storing at least a second rule useable to identify at least a second relationship between clients, after the step of indicating a desire to access at least a specific subset of a second client's account information, applying the at least a second rule to determine if the at least a second relationship exists between the first and second clients and, where the second relationship exists between the first and second clients, performing a secondary function.

39. The method of claim 38 wherein the secondary function includes providing a notice to a system administrator that access to the subset of the second client's account information has been requested.

40. The method of claim 27 wherein the method further includes the step of providing a notice to the second client that the first client has been authorized to access the specific subset of the second client's account information.

41. The method of claim 40 further including the step of providing tools to enable the second client to alter the information subset accessible to the first client.

42. A method for use with a computer network system including a server, a database and a plurality of interfaces wherein client medical information is stored in separate client accounts for each of a plurality of clients, the interfaces for accessing client account information, the method for facilitating client access to other client information, the method comprising the steps of:
storing at least one rule useable to identify at least a first relationship between clients;
applying the at least one rule to at least a subset of the client information to identify if at least first and second clients have the at least a first relationship; and
where the first relationship exists between the first and second clients, allowing the first client to access at least a first subset of the second client's account information.

43. The method of claim 42 wherein the step of allowing access includes providing information via the first interface indicating authority to access the first client's account information.

44. The method of claim 43 wherein the step of providing information indicating authority includes providing hyperlink text that is selectable via the interface to access the first subset.

45. The method of claim 42 further including the steps of performing an access obtaining process to grant the first client access to at least a second subset of the second client's account information and, when the first client accesses information corresponding to the second client, simultaneously presenting the first and second subsets of information in an additive fashion.

46. The method of claim 45 wherein the access obtaining process includes one of the second client granting the first client authority to access the second subset and the first client requesting authority to access the second subset.

47. A method for use with a computer network system including a server, a database and a plurality of interfaces wherein client medical information is stored in separate client accounts for each of a plurality of clients, the interfaces for accessing client account information, the method for facilitating client access to other client information, the method comprising the steps of:
accessing a first client's account via one of the interfaces;
via the first client's account, indicating a desire to access at least a specific subset of a second client's account information; and
providing a notice to the second client that another client has attempted to access at least a subset of the second client's account information.

48. The method of claim 47 further including the step of, when the notice is provided to the second client, allowing the second client to authorize the access sought by the first client.

49. A method for use with a computer network system including a server, a database and a plurality of interfaces wherein client medical information is stored in separate client accounts for each of a plurality of clients including at least a first client, the interface for accessing client account information, the method for authorizing at least another client to access at least a portion of the first client's account information via the interface, the method comprising the steps of:
via one of the interfaces:
accessing the first client's account; and
via the first client's account, identifying at least a first subset of the first client's account information that may be accessed by at least a second client.

50. The method of claim 49 wherein the step of identifying includes identifying at least a second subset of the first client's account information that the at least a second client may not access.

51. The method of claim 49 wherein the first client's account information includes at least two subsets of information and wherein the step of identifying at least a first subset includes presenting the at least two subsets for selection and receiving a selection of at least one of the presented subsets.

52. The method of claim 49 further including the step of, after identifying, allowing the at least a second client to access the first subset of information via one of the interfaces.

53. The method of claim 52 further including the step of specifying a time period during which the first subset of information can be accessed.

54. A method for use with a computer network system including a server, a database and at least one interface wherein client medical information is stored in separate client accounts for each of a plurality of clients including at least a first client, the interface for accessing client account information, the method for presenting client account information for multiple clients in an organized fashion, the method comprising the steps of:
via one of the interfaces:
accessing a first client's account; and
presenting information from a plurality of client accounts via the first client's account.

55. The method of claim 54 wherein the client account information includes appointment schedules for at least a subset of the clients associated with the plurality of clients, the step of presenting including providing a schedule that includes appointments for at least two clients.

56. The method of claim 55 wherein the step of providing a schedule includes providing a calendar that indicates appointments for at least two clients.

57. The method of claim 56 wherein the step of presenting includes providing an interface input that allows the first client to switch between information associated with each of the plurality of client accounts.

58. The method of claim 57 wherein the interface input includes a window including a separately selectable hyperlink element for each of the plurality of client accounts wherein, when one of the hyperlink elements is selected, the method includes presenting information related to the client associated with the selected element.

59. The method of claim 54 further including the step of providing a scheduling input via the first client's account that allows the first client to attempt to schedule appointments for each of at least first and second clients at the same time.

60. A method for use with a computer network system including a server, a database and a plurality of interfaces wherein client medical information is stored in separate client accounts for each of a plurality of clients including at least a first client, the interface for submitting information related to a client, the method for authorizing a second client to submit information on behalf of at least a first client via one of the interfaces, the method comprising the steps of:
via one of the interfaces:
accessing the first client's account; and
via the first client's account, authorizing the second client to submit at least a first type of information on behalf of the first client; and
storing an indication in the database indicating that the second client is authorized to enter the at least a first type of information on behalf of the first client.

61. The method of claim 60 wherein the step of authorizing the second client to submit at least at least a first type of information includes authorizing the second client to at least one of schedule appointments for the first client, request medication renewals for the first client, enter patient related data on behalf of the first client, submit historical information related to the first client, fill out forms for the first client and submit medical questions to physicians on behalf of the first client.

62. A method for use with a computer network system including a server, a database and a plurality of interfaces wherein client medical information is stored in separate client accounts for each of a plurality of clients, the interfaces for accessing client account information, the method for authorizing a first client to submit information on behalf of a second client, the method comprising the steps of:
storing at least one rule useable to identify at least a first relationship between clients;
accessing a first client's account via one of the interfaces;
via the first client's account, indicating a desire to submit at least a first type of information on behalf of a second client;
applying the at least one rule to determine if the at least a first relationship exists between the first and second clients; and
where the first relationship exists between the first and second clients, allowing the fist client to submit the at least a first type of information on behalf of the second client.

63. The method of claim 62 wherein the step of allowing the second client to submit at least at least a first type of information includes allowing the second client to at least one of schedule appointments for the first client, request medication renewals for the first client, enter patient related data on behalf of the first client, submit historical information related to the first client, fill out forms for the first client and submit medical questions to physicians on behalf of the first client.
